(19) United States
(12) Patent Application Publication
(10) Pub. No.: US 2008/0238861 A1
(43) Pub. Date: Oct. 2, 2008

(54) BACKLIGHT CONTROL APPARATUS AND BACKLIGHT CONTROL METHOD

(75) Inventor: Yuichi Honda, Fukaya-shi (JP)

Correspondence Address: BLAKELY SOKOLOFF TAYLOR & ZAFMAN LLP, 1279 OAKMEAD PARKWAY, SUNNYVALE, CA, 94085-4040, US

(73) Assignee: KABUSHIKI KAISHA TOSHIBA, Tokyo (JP)

(21) Appl. No.: 12/044,755

(22) Filed: Mar. 7, 2008

(30) Foreign Application Priority Data
Mar. 29, 2007 (JP) 2007-086119

(51) Int. Cl. G09G 3/36

(52) U.S. Cl. 345/102; 382/168

(57) ABSTRACT

According to one embodiment, a backlight control apparatus includes a conversion unit which, upon receipt of a video signal in the YCbCr standard, converts the video signal into a video signal in the RGB standard, a generation unit which select one signal of the maximum gradient based on pixel-by-pixel comparison of the R video signal, G video signal, and B video signal to generate a histogram in which the gradient of the selected signal is successively plotted, filter units which detect a histogram having a specific distribution from histograms generated by the generation unit, and control units which generate and output a control signal in accordance with a detection result from the filter units.

### CROSS-REFERENCE TO RELATED APPLICATIONS

This application is based upon and claims the benefit of priority from Japanese Patent Application No. 2007-086119, filed Mar. 29, 2007, the entire contents of which are incorporated herein by reference.

### BACKGROUND

1. Field

One embodiment of the invention relates to a backlight control apparatus using a histogram, and in particular, relates to a backlight control apparatus and a backlight control method using a histogram concerning a video signal in the RGB standard.

2. Description of the Related Art

With widespread use of liquid crystal displays in recent years, wide-ranging demands have been made for a method of controlling a backlight apparatus in the liquid crystal displays. That is, when backlight control should be performed not only for luminance, but also for saturation, a technology is known by which backlight control is performed in accordance with a result of calculation carried out for video signals in the RGB standard, instead of those in the YCbCr standard.

Patent Document 1 (Jpn. Pat. Appln. KOKAI Publication No. 2005-242300) discloses an example in which backlight control is performed based on a result of calculation of frequencies of each of an R signal, a G signal, and a B signal. Detailed backlight control is thereby enabled not only for luminance, but also for saturation and therefore, when a screen of high saturation, though the luminance level is low, such as a blue-back screen is controlled, the blue-back screen will not be blackish.

However, since frequencies of each of the R signal, G signal, and B signal are counted in the prior art described in Patent Document 1, amounts of operation processing will increase enormously, placing heavy loads on circuits.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a block diagram exemplifying a configuration of a backlight control apparatus according to one embodiment of the invention;

FIG. 2 is a characteristic chart exemplifying characteristics of a bright section extraction filter for use in the backlight control apparatus according to one embodiment of the invention;

FIG. 3 is a characteristic chart exemplifying characteristics of a dark section extraction filter for use in the backlight control apparatus according to one embodiment of the invention;

FIG. 4 is a block diagram exemplifying a configuration of a broadcast receiver in which the backlight control apparatus according to one embodiment of the invention is used;

FIG. 5 is a flow chart exemplifying control processing of the backlight control apparatus according to one embodiment of the invention;

FIG. 6 is an explanatory diagram exemplifying YCbCr components of a video signal handled by the backlight control apparatus according to one embodiment of the invention;

FIG. 7 is an explanatory diagram exemplifying RGB components of the video signal handled by the backlight control apparatus according to one embodiment of the invention;

FIG. 8 is an explanatory diagram exemplifying a histogram of a Y signal of the video signal handled by the backlight control apparatus according to one embodiment of the invention;

FIG. 9 is an explanatory diagram exemplifying the histogram of a MAX value of RGB of the video signal handled by the backlight control apparatus according to one embodiment of the invention;

FIG. 10 is an explanatory diagram exemplifying a change of PWM pulse output by the Y signal from the backlight control apparatus according to one embodiment of the invention;

FIG. 11 is an explanatory diagram exemplifying another change of PWM pulse output by an RGB signal from the backlight control apparatus according to one embodiment of the invention;

FIG. 12 is an explanatory diagram exemplifying the change of a light amount of backlight by the Y signal from the backlight control apparatus according to one embodiment of the invention;

FIG. 13 is an explanatory diagram exemplifying the change of the light amount of backlight by the RGB signal from the backlight control apparatus according to one embodiment of the invention;

FIG. 14 is an explanatory diagram exemplifying the amount of control of a PWM pulse width of a dark section by the Y signal by the backlight control apparatus according to one embodiment of the invention;

FIG. 15 is an explanatory diagram exemplifying the amount of control of the PWM pulse width of a bright section by the RGB signal by the backlight control apparatus according to one embodiment of the invention;

FIG. 16 is a block diagram exemplifying another configuration of the backlight control apparatus according to one embodiment of the invention;

FIG. 17 is a characteristic chart exemplifying characteristics of a bright section extraction filter for use in the backlight control apparatus according to one embodiment of the invention;

FIG. 18 is a characteristic chart exemplifying characteristics of a dark section extraction filter for use in the backlight control apparatus according to one embodiment of the invention;

FIG. 19 is a characteristic chart exemplifying characteristics of a high saturation extraction filter for use in the backlight control apparatus according to one embodiment of the invention;

FIG. 20 is a flow chart exemplifying control processing by Y, Cb, and Cr of the backlight control apparatus according to one embodiment of the invention; and

FIG. 21 is an explanatory diagram exemplifying the histogram of Y, Cb, and Cr of the video signal handled by the backlight control apparatus according to one embodiment of the invention.

### DETAILED DESCRIPTION

Various embodiments according to the invention will be described hereinafter with reference to the accompanying drawings. In general, according to one embodiment of the invention, which has been made in view of the above circumstances, a backlight control apparatus and a backlight control method are provided that enable backlight control concerning saturation of video signals while keeping processing loads at a relatively low level.

One embodiment to solve the above problem is a backlight control apparatus that includes:

a control unit (1) which, upon receipt of a video signal in the YCbCr standard, converts the video signal into a video signal in the RGB standard;

a generation unit (2) which selects one signal of the maximum gradient based on pixel-by-pixel comparison of the R video signal, G video signal, and B video signal from the conversion unit to generate a histogram in which the gradient of the selected signal is successively plotted;

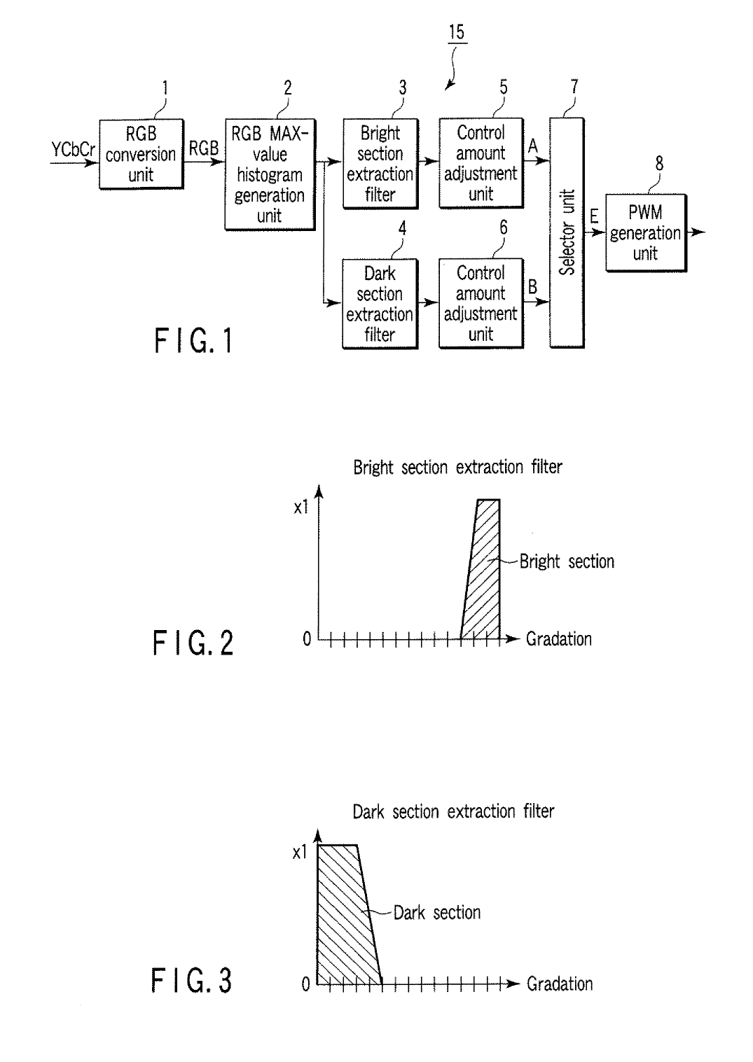

filter units (3, 4) which detect a histogram having a specific distribution (FIG. 2, FIG. 3) from histograms generated by the generation unit; and

control units (5, 6) which generate and output a control signal in accordance with a detection result from the filter units.

Accordingly, a backlight control apparatus reflecting saturation with a low load of about ⅓ is enabled by generating and utilizing a histogram in which the gradient of one signal of the maximum gradient is successively plotted by pixel-by-pixel comparison, instead of generating all histograms of the R video signal, G video signal, and B video signal.

Embodiments of the invention will be described in detail below with reference to the accompanying drawings.

<Backlight Control Unit of an RGB MAX-Value Histogram, which is One Embodiment According to the Invention>

First, a backlight control apparatus, which is one embodiment according to the invention, and an example of a broadcast receiver in which the backlight control apparatus is used will be described in detail with reference to the accompanying drawings. FIG. 1 is a block diagram exemplifying a configuration of a backlight control apparatus according to one embodiment of the invention. FIG. 2 is a characteristic chart exemplifying characteristics of a bright section extraction filter for use in the backlight control apparatus. FIG. 3 is a characteristic chart exemplifying characteristics of a dark section extraction filter for use in the backlight control apparatus.

(Configuration)

A backlight control unit 15, which is one embodiment according to the invention, includes, as shown in FIG. 1, an RGB conversion unit 1 which, upon receipt of a video signal in the YCbCr standard, converts the video signal into a video signal in the RGB standard, an RGB MAX-value histogram generation unit 2 which, upon receipt of an RGB signal from the RGB conversion unit 1, selects one of the R signal, G signal, and B signal with the maximum gradation for each pixel, a bright section extraction filter 3 which filters only a bright section of a histogram before outputting a detection signal to a subsequent stage, and a dark section extraction filter 4 which similarly filters only a dark section of the histogram before outputting a detection signal to the subsequent stage.

Further, the backlight control unit 15, which is one embodiment according to the invention, includes, as shown in FIG. 1, a control amount adjustment unit 5 which, upon receipt of a detection output of the bright section extraction filter 3, outputs a control signal based on the detection output, a control amount adjustment unit 6 which, upon receipt of a detection output of the dark section extraction filter 4, outputs a control signal based on the detection output, a selector unit 7 which, upon receipt of each control signal from the control amount adjustment unit 5 and control amount adjustment unit 6, selectively outputs the control signal to the subsequent stage, and a PWM generation unit 8 which outputs a PWM control signal for controlling a backlight unit in accordance with the control signal from the selector unit 7 to the subsequent stage.

Here, when the bright section extraction filter 3 detects a histogram having a predetermined amount of frequency or more in the maximum gradation of the histogram as shown in FIG. 2, the bright section extraction filter 3 outputs a detection signal to the subsequent stage. Similarly, when the dark section extraction filter 4 detects a histogram having a predetermined amount of frequency or more in the minimum gradation of the histogram as shown in FIG. 3, the dark section extraction filter 4 outputs a detection signal to the subsequent stage.

In the backlight control unit 15 configured as described above, it is preferable, for example, to suppress the backlight to about 80% after detection by the bright section extraction filter 3 and to about 20% after detection by the dark section extraction filter 4, and to control the backlight to about 100% at other timings.

(Example of Broadcast Receiver Using the Backlight Control Unit)

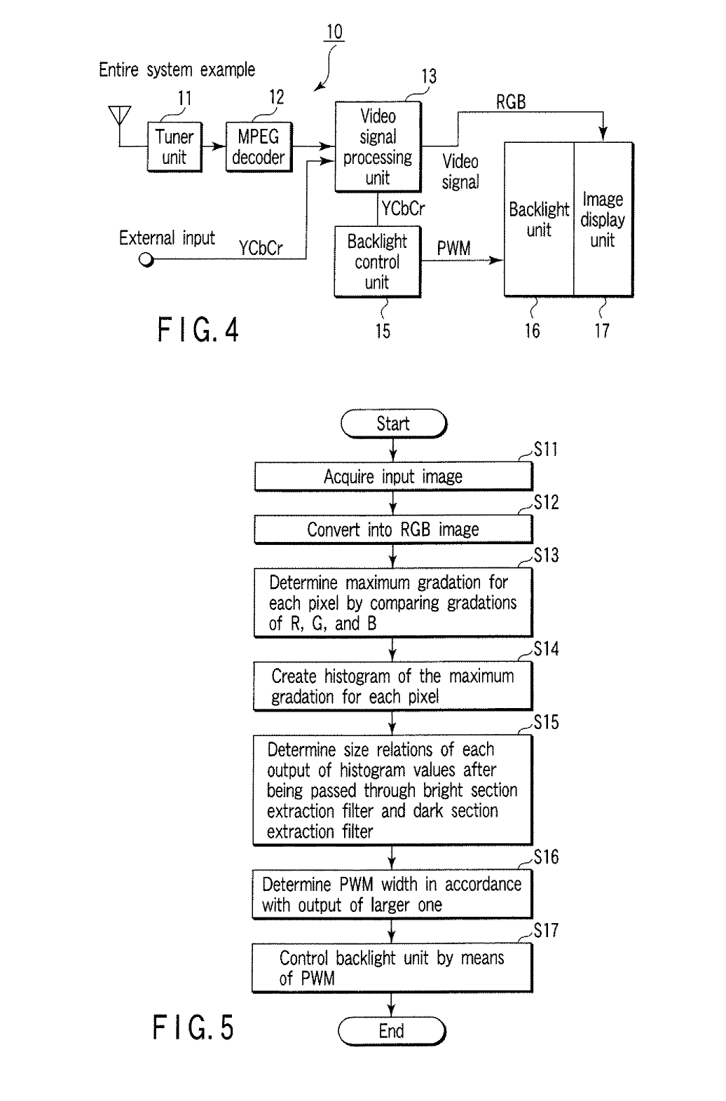

Next, an example of a broadcast receiver using the backlight control unit will be described with reference to the accompanying drawings. FIG. 4 is a block diagram exemplifying a configuration of the broadcast receiver in which the backlight control unit, which is one embodiment according to the invention, is used.

A broadcast receiver 10 in which the backlight control unit 15, which is one embodiment according to the invention, is used includes a tuner unit 11, an MPEG decoder 12 and a video signal processing unit 13. The tuner unit 11 receives a broadcast signal from an antenna unit and performs demodulation processing on the tuned broadcast signal to output the demodulated signal to the subsequent stage. The MPEG decoder 12 decodes the demodulated signal from the tuner unit 11 to output a video sound signal to the subsequent stage. The video signal processing unit 13 performs predetermined processing on the video sound signal from the MPEG decoder 12 to output a video signal in the RGB standard to the subsequent stage.

Further, the broadcast receiver 10 in which the backlight control unit 15, which is one embodiment according to the invention, is used also includes an image display unit 17 such as an LC plane display device, a backlight unit 16 and the backlight control unit 15. The image display unit 17 displays a video based on the video signal in the RGB standard from the video signal processing unit 13 on a screen. The backlight unit 16 irradiates the image display unit 17 with backlight from behind. The backlight control unit 15, upon receipt of a video signal in the YCbCr standard from the video signal processing unit 13, as described later, converts the video signal into a video signal in the RGB standard to generate a histogram of the maximum gradation and, based on the histogram, outputs a PWM control signal of the backlight unit 16.

(Operation of the Backlight Control Unit)

Next, the backlight control operation of the above-mentioned backlight control unit 15 will be described in detail with reference to a flow chart. FIG. 5 is a flow chart exemplifying control processing of the backlight control apparatus according to one embodiment of the invention. Incidentally, each step in the flow chart of FIG. 5 can be replaced by a circuit block and therefore, each of the steps of the flow chart can all be redefined as a block.

That is, the backlight control unit 15 according to one embodiment of the invention converts a video signal in the YCbCr standard into a video signal in the RGB standard, selects one signal having the maximum gradient based on pixel-by-pixel comparison of the R video signal, G video signal, and B video signal, and generates a histogram by successively plotting the gradient of the selected signal. Then, the backlight control unit 15 detects a histogram having a specific distribution (FIG. 2, FIG. 3) from these histograms using a filter or the like, and generates a PWM control signal in accordance with a detection result to output the control signal.

That is, if a video signal in the YCbCr standard is given in the backlight control unit 15 according to one embodiment of the invention (step S11), the video signal in the YCbCr standard is converted into a video signal in the RGB standard by the RGB conversion unit 1 (step S12). Next, in the RGB MAX-value histogram generation unit 2, pixel-by-pixel comparison of gradations of the R video signal, G video signal, and B video signal is performed to select one video signal having the maximum gradation and the frequency is plotted for the gradient of the video signal (step S13). A histogram is generated in this manner by the maximum gradation of the R video signal, G video signal, or B video signal being plotted for all pixels of a screen in the RGB MAX-value histogram generation unit 2 (step S14). By way of example, one histogram is preferably generated for one screen. However, the embodiment of the invention is not limited to this method.

Next, outputs of many histograms generated in this manner after being passed through the bright section extraction filter 3 and the dark section extraction filter 4 are supplied to the control amount adjustment unit 5 and the control amount adjustment unit 6 respectively, and size relations of outputs of the control amount adjustment unit 5 and the control amount adjustment unit 6 are determined by the selector unit 7 (step S15). For example, an output of the bright section extraction filter 3 may be larger or that of the dark section extraction filter 4 may be larger. A larger output is selected by the selector unit 7 and supplied to the PWM generation unit 8, and the PWM width is determined by the PWM generation unit 8 in accordance with the larger output (step S16). Then, the output of the PWM generation unit 8 is supplied to the backlight unit 16 as the output of the backlight control unit 15 to control the backlight unit (step S17).

(Comparison of Backlight Control by Y Luminance Signal and Backlight Control by RGB Standard Signal)

Next, backlight control by a Y luminance signal and that by the above-mentioned RGB standard signal will be compared in each signal stage to describe differences between them using the accompanying drawings.

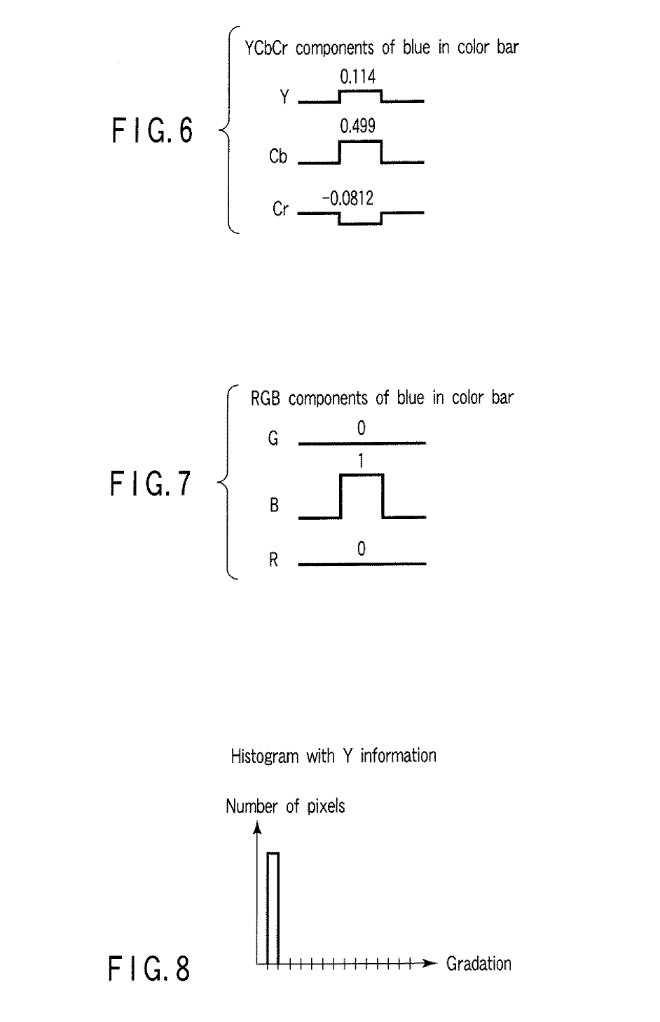

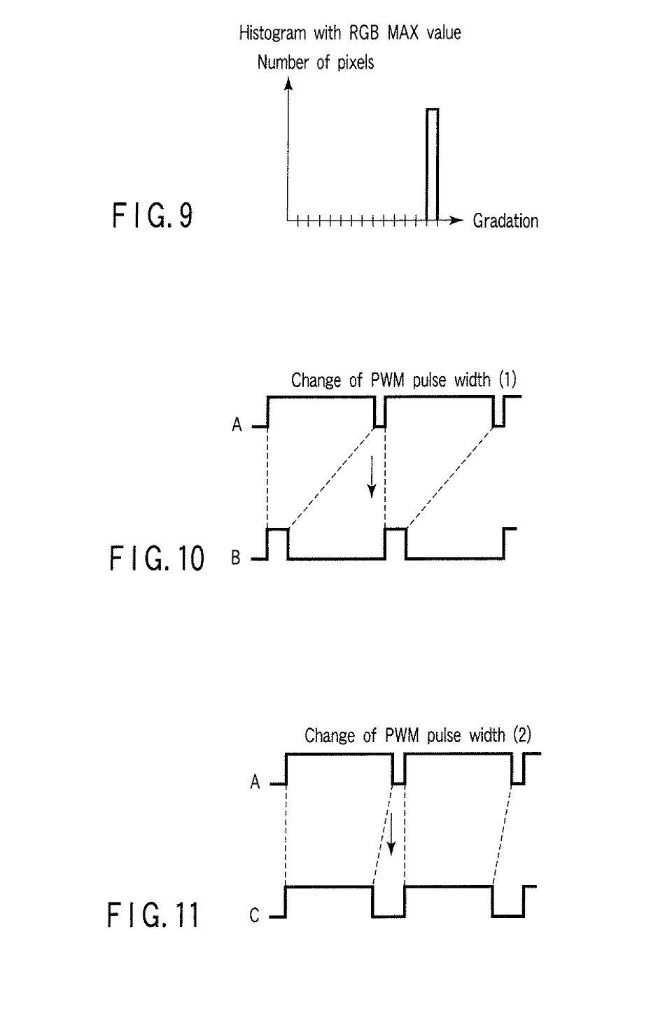

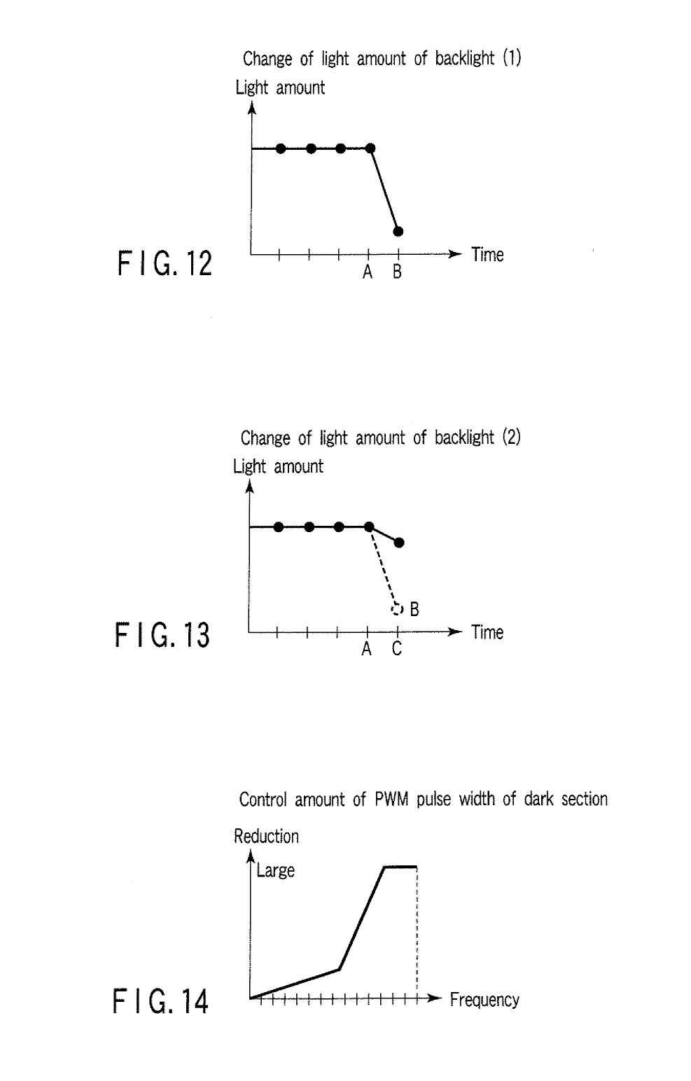

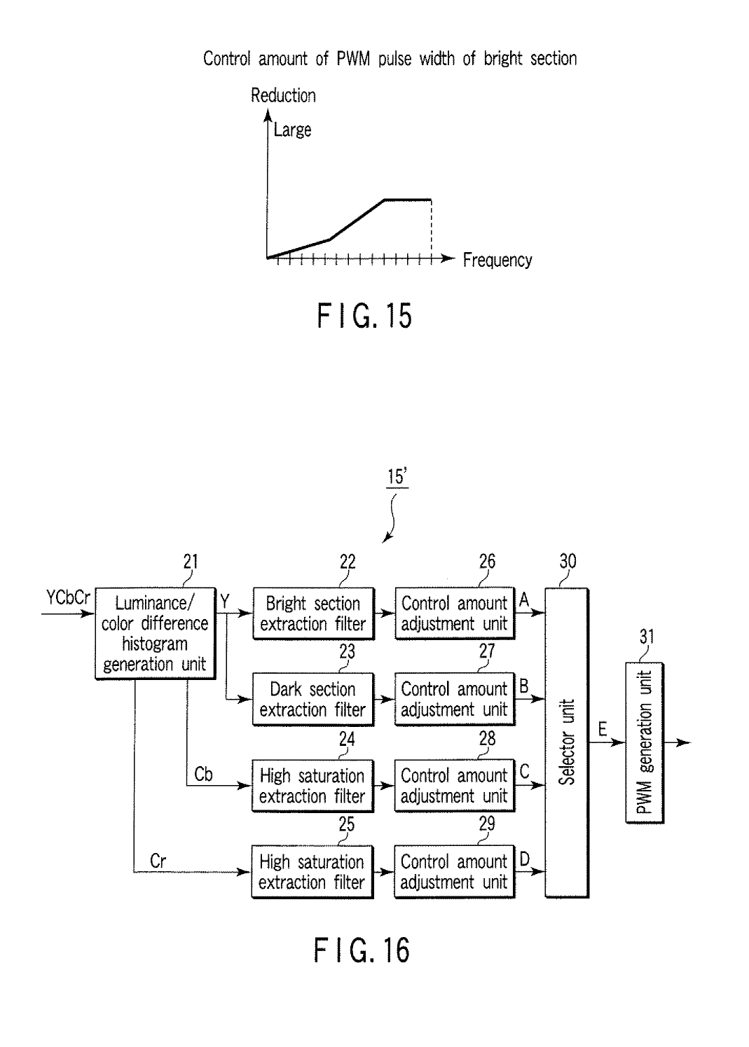

FIG. 6 is an explanatory diagram exemplifying YCbCr components of a video signal handled by the backlight control apparatus according to one embodiment of the invention, and FIG. 7 is an explanatory diagram exemplifying RGB components of the video signal. FIG. 8 is an explanatory diagram exemplifying a histogram of a Y signal of the video signal, and FIG. 9 is similarly an explanatory diagram exemplifying the histogram of a MAX value of RGB of the video signal. FIG. 10 is an explanatory diagram exemplifying a change of PWM pulse output by the Y signal, and FIG. 11 is similarly an explanatory diagram exemplifying another change of PWM pulse output by an RGB signal. FIG. 12 is an explanatory diagram exemplifying the change of a light amount of backlight by the Y signal, and FIG. 13 is an explanatory diagram exemplifying the change of the light amount of backlight by the RGB signal. FIG. 14 is an explanatory diagram exemplifying the amount of control of a PWM pulse width of a dark section by the Y signal, and FIG. 15 is an explanatory diagram exemplifying the amount of control of the PWM pulse width of a bright section by the RGB signal.

That is, backlight control by the Y luminance signal and that by the RGB standard signal will be compared for a blue-back screen having high saturation, though the luminance level is relatively low, to describe differences between them in detail.

FIG. 6 shows YCbCr components when the blue back is blue in the color bar for backlight control by the Y luminance signal. The ratio of Y, Cb, and Cr is Y:Cb:Cr=0.114:0.499:−0.0812. Here, the blue-back screen is not detected as a component of high gradation with a high frequency.

FIG. 7 shows RGB components when the blue back is blue in the color bar for backlight control by the RGB standard signal. The ratio of R, G, and B is R:G:B=0:0:1. Here, the blue-back screen can be detected as a high frequency at a high level of saturation of B.

FIG. 8 shows a histogram with Y information for backlight control by the Y luminance signal. Here, the blue-back screen shows a high frequency for a low gradation (dark) component.

FIG. 9 shows a histogram with a MAX value of RGB for backlight control by the RGB standard signal. Here, the blue-back screen shows a high frequency for a high-saturation component of the G video signal.

FIG. 10 shows a change of the PWM pulse width caused by a low gradation (dark) component with a high frequency being shown for backlight control by the Y luminance signal and backlight output is suppressed, for example, to about 20%. As a result, the blue-back screen is displayed darkly.

FIG. 11 shows a change of the PWM pulse width caused by a high-saturation component with a high frequency of the G video signal being shown for backlight control by the RGB standard signal and backlight output is suppressed, for example, to about 80%. As a result, the blue-back screen can be displayed relatively brightly.

FIG. 12 shows a backlight output of, for example, about 20% for backlight control by the Y luminance signal, revealing that the blue-back screen is displayed darkly.

FIG. 13 shows a backlight output of, for example, about 80% for backlight control by the RGB standard signal, revealing that the blue-back screen is displayed relatively brightly.

FIG. 14 shows the amount of control of the PWM pulse width of a dark section for backlight control by the Y luminance signal. It is evident that the blue-back screen is handled as a dark section and displayed darkly.

FIG. 15 shows the amount of control of the PWM pulse width of a bright section for backlight control by the RGB standard signal. It is evident that the blue-back screen is handled as a bright section and displayed relatively brightly.

With a backlight control apparatus according to an embodiment of the invention, as described above, backlight control by an RGB standard signal is performed to enable backlight control to be performed in such a way that, for example, a blue-back screen of high saturation, though the luminance level is low, is displayed relatively brightly. Further, in histogram generation for an RGB video signal, processing loads can be reduced to ⅓ at the maximum by generating a MAX histogram for each pixel of the RGB video signal.

<Backlight Control Unit of Luminance/Saturation Histogram, which is Another Embodiment According to the Invention>

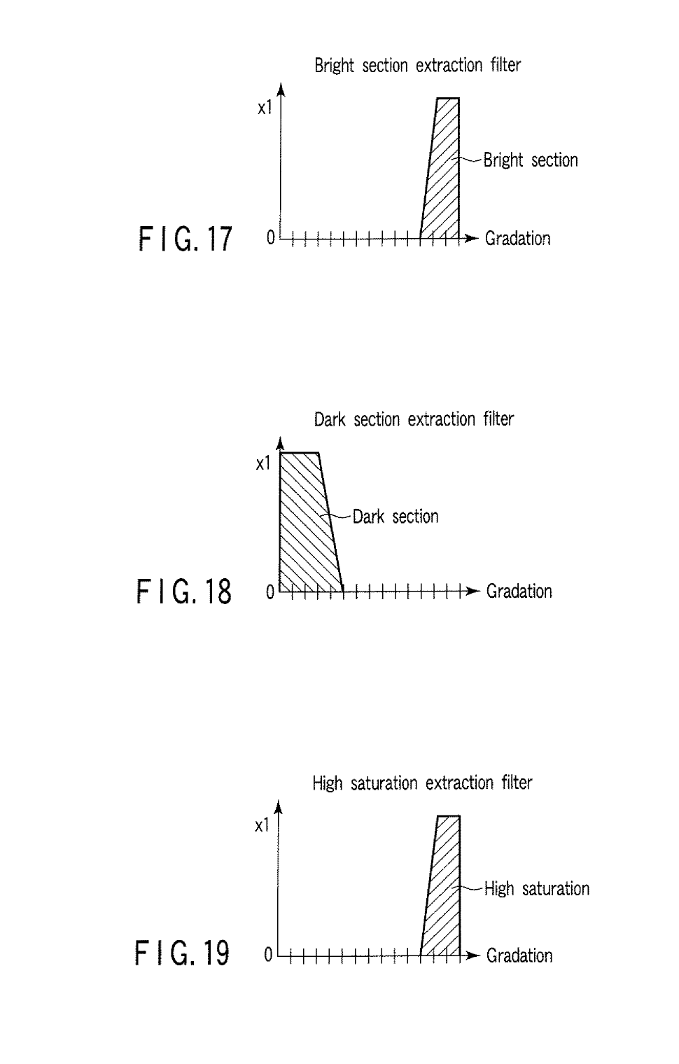

Next, a backlight control unit of a luminance/saturation histogram, which is another embodiment according to the invention, will be described in detail with reference to the accompanying drawings. FIG. 16 is a block diagram exemplifying another configuration of the backlight control apparatus according to one embodiment of the invention. FIG. 17 is a characteristic chart exemplifying characteristics of a bright section extraction filter for use in the backlight control apparatus. FIG. 18 is a characteristic chart exemplifying characteristics of a dark section extraction filter for use in the backlight control apparatus. FIG. 19 is a characteristic chart exemplifying characteristics of a high saturation extraction filter for use in the backlight control apparatus.

(Configuration)

A backlight control unit 15′, which is one embodiment according to the invention, includes, as shown in FIG. 16, a luminance/color difference histogram generation unit 21, a bright section extraction filter 22 and a dark section extraction filter 23. The luminance/color difference histogram generation unit 21, upon receipt of a video signal in the YCbCr standard, generates a luminance/color difference histogram. The bright section extraction filter 22 filters only a bright section of a histogram to output a detection signal to a subsequent stage. The dark section extraction filter 23 similarly filters only a dark section of the histogram to output a detection signal to the subsequent stage.

Further, the backlight control unit 15′, which is one embodiment according to the invention, includes, as shown in FIG. 16, a high saturation extraction filter 24, a high saturation extraction filter 25, a control amount adjustment unit 26, a control amount adjustment unit 27, a control amount adjustment unit 28, a control amount adjustment unit 29, a selector unit 30, and a PWM generation unit 31. The high saturation extraction filter 24 filters only high saturation of a histogram of a color difference signal Cb to output a detection signal to the subsequent stage. The high saturation extraction filter 25 similarly filters only high saturation of a histogram of a color difference signal Cr to output a detection signal to the subsequent stage. The control amount adjustment unit 26, upon receipt of a detection output of the bright section extraction filter 22, outputs a control signal based on the detection output. The control amount adjustment unit 27, upon receipt of a detection output of the dark section extraction filter 23, outputs a control signal based on the detection output. The control amount adjustment unit 28, upon receipt of a detection output of the high saturation extraction filter 24 for the color difference signal Cb, outputs a control signal based on the detection output. The control amount adjustment unit 29, upon receipt of a detection output of the high saturation extraction filter 25 for the color difference signal Cr, outputs a control signal based on the detection output. The selector unit 30, upon receipt of each control signal from the control amount adjustment unit 26 to the control amount adjustment unit 29, selectively outputs the control signal to the subsequent stage. The PWM generation unit 31 outputs a PWM control signal for controlling a backlight unit in accordance with the control signal from the selector unit 30 to the subsequent stage.

Here, when the bright section extraction filter 22 detects a predetermined amount of frequency or more in the maximum gradation of a histogram, as shown in FIG. 17, the bright section extraction filter 22 outputs a detection signal to the subsequent stage.

When the dark section extraction filter 23 detects a predetermined amount of frequency or more in the minimum gradation of a histogram, as shown in FIG. 18, the dark section extraction filter 23 outputs a detection signal to the subsequent stage.

Moreover, when the high saturation extraction filter 24 for the color difference signal Cb detects a predetermined amount of frequency or more in the maximum high saturation of a histogram, as shown in FIG. 19, the high saturation extraction filter 24 outputs a detection signal to the subsequent stage.

Similarly, when the high saturation extraction filter 25 for the color difference signal Cr detects a histogram having a predetermined amount of frequency or more in the maximum high saturation of the histogram, as shown in FIG. 19, the high saturation extraction filter 25 also outputs a detection signal to the subsequent stage.

(Operation of the Backlight Control Unit)

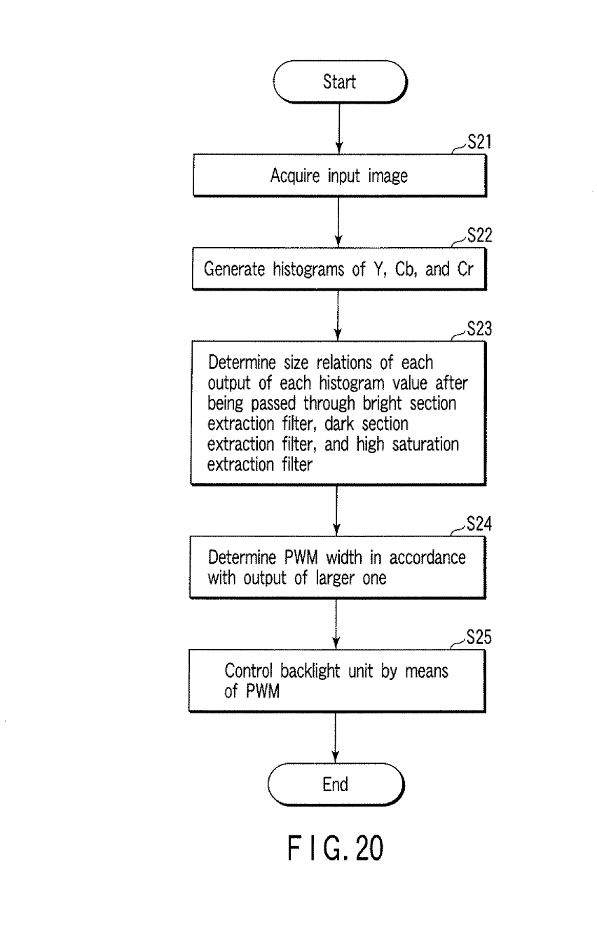

Next, the backlight control operation of the above-mentioned backlight control unit 15′ will be described in detail using a flow chart. FIG. 20 is a flow chart exemplifying control processing by Y, Cb, and Cr of a backlight control apparatus according to one embodiment of the invention. Incidentally, each step in the flow chart of FIG. 20 can be replaced by a circuit block and therefore, each of the steps of the flow chart can all be redefined as a block.

That is, the backlight control unit 15′ according to one embodiment of the invention generates a histogram for each video signal in the YCbCr standard. Then, the backlight control unit 15′ detects a histogram having a specific distribution (FIG. 17, FIG. 18, FIG. 19) from these histograms using a filter or the like to generate and output a PWM control signal in accordance with a detection result.

That is, if a video signal in the YCbCr standard as shown in the flow chart of FIG. 20 is given in the backlight control unit 15′ according to one embodiment of the invention (step S21), a histogram is generated for each of the luminance signal Y, color difference signal Cb, and color difference signal Cr by the luminance/color difference histogram generation unit 21 (step S21). For example, one histogram is preferably generated for each of the luminance signal Y, color difference signal Cb, and color difference signal Cr of each screen, but the invention is not limited to this method.

Next, outputs of many histograms generated in this manner after being passed through the bright section extraction filter 22, dark section extraction filter 23, high saturation extraction filter 24 for Cb, and high saturation extraction filter 25 for Cr are supplied to the control amount adjustment unit 26, control amount adjustment unit 27, control amount adjustment unit 28, and control amount adjustment unit 29 respectively, and size relations of outputs of each control amount adjustment unit are determined by the selector unit 30 (step S23). For example, an output of the bright section extraction filter 22 may be larger or an output of the dark section extraction filter 23 may be larger. A larger output is selected by the selector unit 30 and supplied to the PWM generation unit 31, and the PWM width is determined by the PWM generation unit 30 in accordance with the larger output (step S24). Then, the output of the PWM generation unit 31 is supplied to the backlight unit 16 as the output of the backlight control unit 15′ to control the backlight unit (step S25).

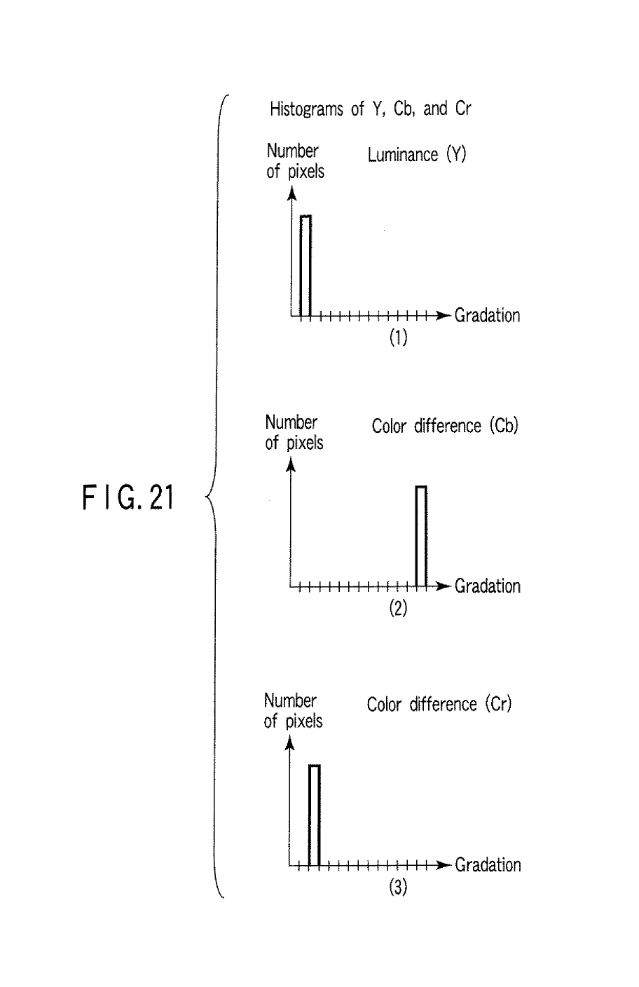

That is, also in the backlight control unit 15′ shown in FIG. 16, if the blue back of blue in the color bar in FIG. 3 is input into an input image, a histogram is obtained for each of Y, Cb, and Cr as shown in FIG. 21. While Y shows a dark video with many histogram values of low gradations, it is determined that Cb is a video with high saturation because there are many histogram values of high gradations. Therefore, like the backlight control unit 15 shown in FIG. 1, control to slightly reduce the light amount of backlight (for example, about 80%) as a change of the light amount of backlight is performed for the blue-back screen, and the screen changes in a direction of slight darkening. Thus, a video of high saturation, though the luminance level is low, such as a blue-back screen will not be blackish.

### Another Embodiment

As another embodiment, a configuration is preferably provided in which both configurations of the backlight control unit 15 shown in FIG. 1 and the backlight control unit 15′ shown in FIG. 16 are prepared and outputs of both are optionally switched by a switch or the like to supply them to the backlight unit 16. Accordingly, the user can control the backlight 16 by the backlight control unit 15 or the backlight control unit 15′ according to the circumstances.

According to this embodiment, the user can attempt backlight control by both control methods and, the optimal backlight control in accordance with video characteristics can be achieved by optionally selecting the control method in accordance with the circumstances.

### Another Embodiment

As still another embodiment, for carrying out the invention, the invention is not necessarily limited to the PWM generation unit 8 shown in FIG. 1. Therefore, any other backlight drive unit may be used.

As an example, a voltage value generation unit that controls the light amount of backlight by the voltage value of drive voltage in accordance with the type of the backlight unit 16 is preferably provided, instead of the PWM generation unit 8.

A person skilled in the art can achieve the invention by various embodiments described above and further, the person skilled in the art can easily think of various modifications of such embodiments and can apply such modifications to various embodiments without inventive capabilities. Therefore, the invention extends to a wider scope that is consistent with the disclosed principles and new features and is not limited to the above-mentioned embodiments.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A backlight control apparatus comprising:
a conversion unit which, upon receipt of a video signal in a YCbCr standard, converts the video signal into a video signal in an RGB standard;
a generation unit which selects one signal of the maximum gradient based on pixel-by-pixel comparison of the R video signal, G video signal, and B video signal from the conversion unit to generate a histogram in which a gradient of the selected signal is successively plotted;
filter units which detect a histogram having a specific distribution from histograms generated by the generation unit; and
control units which generate and output a control signal in accordance with a detection result from the filter units.

2. The backlight control apparatus according to claim 1, wherein the generation unit generates one histogram for one screen of the video signal.

3. The backlight control apparatus according to claim 1, wherein the filter units detect a histogram having a predetermined amount of frequency or more in a maximum gradation.

4. The backlight control apparatus according to claim 1, wherein the filter units detect a histogram having a predetermined amount of frequency or more in a minimum gradation.

5. The backlight control apparatus according to claim 1, further comprising:
a processing unit which, upon receipt of a video signal in the YCbCr standard, outputs a drive signal for displaying an image;
a display unit which, upon receipt of the drive signal from the processing unit, displays a video in accordance with the drive signal in a screen; and
a backlight unit which, upon receipt of the control signal from the control unit, irradiates the display unit with backlight from behind in accordance with the control signal.

6. A backlight control apparatus comprising:
a generation unit which, upon receipt of a video signal in a YCbCr standard, generates a histogram for each of a Y luminance signal, a Cb color difference signal, and a Cr color difference signal;
filter units which detect a histogram having a specific distribution from histograms generated by the generation unit; and
control units which generate and output a control signal in accordance with a detection result from the filter units.

7. The backlight control apparatus according to claim 6, wherein the generation unit generates one histogram for one screen of the video signal.

8. The backlight control apparatus according to claim 6, wherein the filter units detect a histogram having a predetermined amount of frequency or more in a maximum gradation.

9. The backlight control apparatus according to claim 6, wherein the filter units detect a histogram having a predetermined amount of frequency or more in a minimum gradation.

10. The backlight control apparatus according to claim 6, wherein the filter units detect a histogram having a predetermined amount of frequency or more in highest saturation.

11. A backlight control method comprising:
upon receipt of a video signal in a YCbCr standard, converting the video signal into a video signal in an RGB standard;
selecting one signal of the maximum gradient based on pixel-by-pixel comparison of the R video signal, G video signal, and B video signal to generate a histogram in which a gradient of the selected signal is successively plotted;
detecting a histogram having a specific distribution from the generated histograms; and
generating a control signal in accordance with a result of the detection.
